(19) United States
(12) Patent Application Publication
(10) Pub. No.: US 2016/0347392 A1
(43) Pub. Date: Dec. 1, 2016

(54) Fender for a bicycle and method for producing a fender

(71) Applicant: SKS metaplast Scheffer-Klute GmbH, Sundern (DE)

(72) Inventors: Sven Kordes, Sundern (DE); Karsten Grabski, Ense (DE); Sebastian Wedhorn, Dormagen (DE); Patrick Fuchs, Arnsberg (DE)

(21) Appl. No.: 15/154,265

(22) Filed: May 13, 2016

(30) Foreign Application Priority Data
May 29, 2015 (DE) 102015108 549.6

(51) Int. Cl. B62J 15/00; B29C 37/00; B29B 11/14; B60R 13/00; B29C 45/14

(52) U.S. Cl. CPC B62J 15/00; B60R 13/005; B29C 45/14467; B29C 45/14688; B29B 11/14; B29C 37/0025; B60Y 2410/122; B29K 2023/12

(57) ABSTRACT

Fender for a bicycle, including a fender body (1) which is at least partially and/or in sections, made of plastic, and support means (2) for decorations and/or information, wherein the fender body (1) and the support means (2) are firmly connected together by back-molding.

### BACKGROUND OF THE INVENTION

This is an application based on and claiming priority to DE 10 2015 10 549 6 filed on May 29, 2015, which is herein incorporated by reference in its entirety.

The present invention relates to a fender for a bicycle and a method for producing a fender.

Fenders for a bicycle are usually made of plastic, in particular of a polypropylene (PP). Polypropylene belongs to the polymer group of polyolefins and can be printed only with great effort. Injection molded articles made of polypropylene are frequently printed by way of the pad printing process. The quality and precision of pad printing is relatively poor. Furthermore, the article must be transported to the printer after the injection molding process which is relatively complex. Also, printed films having, for example, a label or decoration may be glued onto the fender. However, on the one hand, such films can detach from the fender. On the other hand, such films frequently do not give the fender a high-quality appearance, especially because the user recognizes that the films are different from the actual fender.

The problem addressed by the present invention is to provide a fender of the aforementioned type which is provided with high-quality decorations or information such as labels or other printed text. A method for producing such a fender is also disclosed.

### SUMMARY OF THE INVENTION

This is achieved according to the invention with a fender having the characterizing features of claim 1 and with a method having the features of claim 6. The dependent claims relate to preferred embodiments of the invention.

According to claim 1, the fender body and the support means are firmly connected together by back-molding. Back-molding produces a firm connection between the support means and the fender body. Since the support means are firmly connected with the fender body directly during the injection molding process, costly reworking is no longer needed. In particular, subsequent printing of the fender is averted which results in cost savings.

The support means r may include a label and/or text and/or a decoration and/or a colored area and/or a transparent area. The fender can therefore be provided by way of the support means with labels, icons, backlight technology and multicolored two-dimensional decorations.

The support means may include at least one film or may be composed of at least one film, wherein the at least one film is in particular printed. A film has frequently a simple geometry such as an essentially two-dimensional shape. Thus, the film can be printed in high quality, for example, by using digital printing.

The fender body may be a curved component, preferably with a complex curvature, which is in particular at least in sections shaped as a partial torus. Despite the complex curvature of the fender, the solid connection with the support means produced by back-molding can give the fender an attractive appearance with high quality decorations, or with information such as labels or other printed text.

The fender body and the support means may be at least partially and/or in sections made of the same material, with this material being for example a polypropylene. Selecting identical material for the fender body and the support means ensures a high quality material connection.

The method contemplates the following method steps:
support means are introduced into an injection molding tool,
the support means are back-molded body with a fender.

The support means which include at least one film or which may be composed of least one film are preferably printed before loading into the injection mold. Furthermore, the support means may be trimmed and/or reshaped before being loaded into the injection mold, wherein reshaping may take place in particular after printing. In this way, finished decorated fenders which may in particular have a complex curvature can be produced with the injection molding process.

Further features and advantages of the present invention will become apparent from the following description of preferred exemplary embodiments with reference to the accompanying drawings, which show in:

### BRIEF DESCRIPTION OF THE INVENTION

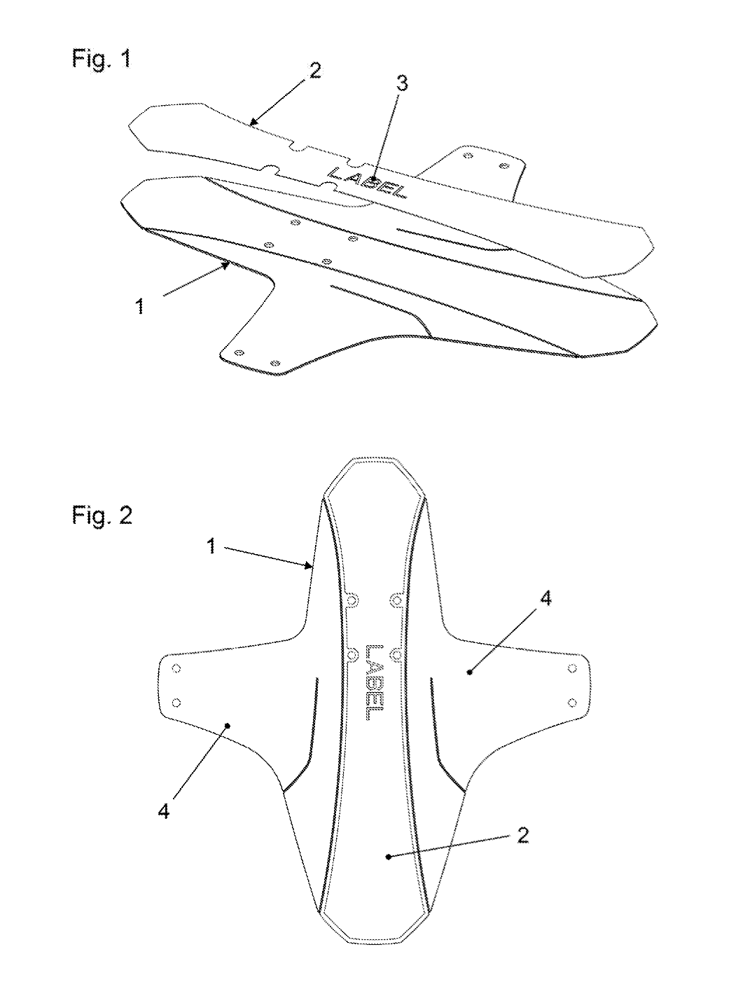

FIG. 1 an exploded view of a fender according, to the present invention,

FIG. 2 a plan view of a fender according to the present invention.

### DETAILED DESCRIPTION OF THE INVENTION

In the figures, identical and functionally identical part e provided with identical reference symbols.

The exemplary embodiment of a fender according to the present invention illustrated in the figures includes a fender body 1 and film serving as support means 2, which is printed with a label. 3 However, more than one film, for example two or three films may be provided.

The fender body 1 has two lateral projections 4 which can be bent downward for attachment to the bicycle, thus producing a fender with an overall shape of a partial torus. However, this shape of a partial torus ay already be produced by the actual injection molding process.

For producing the finished fender depicted in FIG. 2, at least one film serving as support means 2 is printed with the desired information or decorations, optionally trimmed and/or reshaped, and then inserted into an injection mold, where the film can then be held, for example by suction.

In particular, when the fender is to be provided with a complex curvature already during injection molding, for example a shape of a partial torus partially adapted to a wheel of a bicycle, the film is reshaped before being loaded into the injection mold so as to also have a corresponding curvature. In this way, the film can be in intimate contact with the correspondingly shaped mold.

Thereafter, the fender body is produced in the mold by an injection molding process and back-molded behind the film. Since the foil is also heated during injection molding, the film and the fender body 1 are materially connected, in particular when the film and the fender body 1 are made of the same material such as polypropylene.

After removal from the mold, a finished decorated fender is produced, as depicted for example in FIG. 2. Usually, this fender need no longer be reworked after removal.

1. A fender for a bicycle, comprising
a fender body (1) which is at least partially mad plastic, and
a support (2) for decoration and/or information,
wherein the fender body (1) and the support (2) are firmly connected with one another by back-molding.

2. The fender according to claim 1, wherein the support (2) comprises at least one of a label (3), text, a decoration, a colored area and a transparent area.

3. The fender according to claim 1, wherein the support (2) comprises at least one film.

4. The fender according to claim 1, wherein the fender body (1) is curved component.

5. The fender according to claim 1 wherein the fender body (1) and the support (2) are at least partially and/or sections made of the same material, wherein this material is for example a polypropylene.

6. A method for producing a fender, comprising the following method steps:
introducing a support (2) into are ion mold,
providing back-molding of the support (2) with a fender body

7. The Method according to claim 6, further comprising a step of printing the support (2) before being loaded into the injection mold.

8. The method according to claim 6, further comprising a step of trimming the support (2) before being loaded into the injection mold.

9. The method according to claim 6, further comprising a step of reshaping the support (2) before being loaded into the injection molding tool, wherein reshaping is carried out, in particular after the printing.

10. The method according to claim 6, further comprising a step of providing the support (2) with at least one film.

11. The method of claim 6, further comprising a step of producing the support (2) and the fender body (1) at least partially of the same material.

12. The fender for a bicycle according to claim 1, wherein the support (2) includes at least one of decoration and information.

13. The fender for a bicycle according to claim 1, wherein the fender body and the support (2) are firmly connected with one another by back-molding.

14. The fender according to claim 3, wherein the at least one film is printed.

15. The fender according to claim 1, wherein the fender body (1) is a curved component.

16. The fender according to claim 15, wherein the curved component is a complex curvature.

17. The fender according to claim 16, wherein the complex curvature is, at least in sections, shaped as a partial torus.

18. The fender according to claim 5, wherein the fender body (1) and the support (2) are at least partially made of polypropylene.

19. The method according to claim 9, wherein the reshaping in done after the printing.

20. The method according to claim 6, wherein the support (2) consists of at least one film.

21. The method of claim 11, wherein material is a polypropylene.
